(19) United States
(12) Patent Application Publication
(10) Pub. No.: US 2025/0062308 A1
(43) Pub. Date: Feb. 20, 2025

(54) COSOLVENT SLURRY SYSTEM FOR SOLUTION PROCESSING OF SULFIDE SOLID-STATE BATTERY

(71) Applicant: GM GLOBAL TECHNOLOGY OPERATIONS LLC, Detroit, MI (US)

(72) Inventors: Qili Su, Shanghai (CN); Zhe Li, Shanghai (CN); Yong Lu, Shanghai (CN); Haijing Liu, Shanghai (CN)

(21) Appl. No.: 18/480,646

(22) Filed: Oct. 4, 2023

(30) Foreign Application Priority Data
Aug. 18, 2023 (CN) 202311048632.0

(51) Int. Cl. H01M 4/04; H01M 4/485; H01M 4/505; H01M 4/525; H01M 10/052; H01M 10/0562

(52) U.S. Cl. CPC H01M 4/0404; H01M 4/0471; H01M 4/485; H01M 4/505; H01M 4/525; H01M 10/052; H01M 10/0562; H01M 2004/027; H01M 2004/028; H01M 2300/008

(57) ABSTRACT

A method of manufacturing an electrode-forming slurry includes mixing together an active material, an electrically conducting material and optionally a solid state electrolyte with a low-polar solvent. The low-polar solvent has a dipole moment of less than 4 and a boiling point greater than 100° C. to form a first slurry, where the active material is an anode active material or a cathode active material. A polymeric binder and an ether-based solvent are mixed to form second slurry. The first slurry and the second slurry are mixed to form the electrode-forming slurry.

### CROSS-REFERENCE TO RELATED APPLICATIONS

This application claims priority to Chinese Patent Application No. 202311048632.0, filed Aug. 18, 2023, and all the benefits accruing therefrom under 35 U.S.C. § 119, the contents of which in its entirety are herein incorporated by reference.

### INTRODUCTION

The subject disclosure relates to a cosolvent slurry system for use in sulfide solid-state batteries. More specifically, it relates to an ether-based cosolvent slurry system for solution processing of sulfide solid-state batteries.

All-solid-state batteries (ASSB) that employ sulfide electrolytes have the potential to be superior to state-of-the-art lithium-ion battery (LIB) in terms of abuse tolerance and working temperature range. Prototype ASSB's are manufactured using a wet-coating method that employs a solvent and a binder to make sheet-type electrodes. However, the most commonly used solvent in batteries is N-methylpyrrolidone (NMP) which unfortunately, reacts with other ingredients, especially with those used in sulfide solid-state batteries.

Accordingly, it is desirable to provide a solvent that can be used to prepare an electrolyte that does not react with the various ingredients used in batteries.

### SUMMARY

In an exemplary embodiment, a method of manufacturing an electrode-forming slurry includes mixing together an active material, an electrically conducting material and optionally a solid state electrolyte with a low-polar solvent. The low-polar solvent has a dipole moment of less than 4 and a boiling point greater than 100° C. to form a first slurry, where the active material is an anode active material or a cathode active material. A polymeric binder and an ether-based solvent are mixed to form second slurry. The first slurry and the second slurry are mixed to form the electrode-forming slurry.

In another exemplary embodiment, the electrode-forming slurry is disposed on a current collector and subjecting the current collector to an increased temperature.

In yet another exemplary embodiment, the electrode-forming slurry present on the current collector is dried to form the electrode.

In yet another exemplary embodiment, the low-polar solvent has a structure represented by formula CₙH₂ₙ₊₂
(1); or
   CₙH₂ₙ (2); where C is carbon, H is hydrogen and n is an integer greater than 5 and where the structures of formula (1) or formula (2) are substituted or non-substituted.

In yet another exemplary embodiment, the low-polar solvent is pentane, cyclopentane, hexane, cyclohexane, heptane and isomers thereof, toluene, ethylbenzene, p-xylene, m-xylene, o-xylene, anisole, or a combination thereof

In yet another exemplary embodiment, the low-polar solvent is anisole.

In yet another exemplary embodiment, the ether-based solvent includes an ether having a structure determined by formula (3)

C₂ₙH₂ₙ₊₂O (3), where C is carbon, H is hydrogen, O is oxygen, and where n is an integer greater than 1; and where the structure of formula (3) is substituted or non-substituted.

In yet another exemplary embodiment, the ether-based solvent is dimethyl ether, diethyl ether, dipropyl ether, dibutyl ether, dimethoxymethane, tetraethylene glycol, methyl tert-butyl ether, dimethyl ether, diglyme, ethyl diglyme, butyl diglyme, tetrahydrofuran (THF), dioxane, methyl tert-butyl ether, diisopropyl ether, 2-butoxyethanol, cyclopentyl methyl ether, 2-methyltetrahydrofuran, or a combination thereof.

In yet another exemplary embodiment, the ether-based solvent is dimethyl ether.

In yet another exemplary embodiment, the solid state electrolyte is a pseudobinary sulfide, a pseudoternary sulfide, a pseudoquarternary sulfide, or a combination thereof.

In yet another exemplary embodiment, the solid state electrolyte is Li₆PS₅Cl.

In an exemplary embodiment, a method of manufacturing a solid state electrolyte for a solid state battery includes mixing a low-polar solvent and an ether-based solvent with a solid state electrolyte and a polymeric binder. The low-polar solvent has a dipole moment of less than 4 and a boiling point of greater than 100° C. The solid state electrolyte is a pseudobinary sulfide, a pseudoternary sulfide, a pseudoquarternary sulfide, or a combination thereof.

In an exemplary embodiment, the polymeric binder is poly(vinylidene fluoride-co-chlorotrifluoroethylene), poly(vinylidene fluoride-trifluoroethylene), poly(vinylidene fluoride-trifluoroethylene-chlorofluoroethylene) terpolymer, poly(vinylidene fluoride-hexafluoropropylene), or a combination thereof.

In an exemplary embodiment, a battery includes an anode current collector and an anode active layer disposed on the anode current collector. The anode active layer includes an anode active material, a polymeric binder and an electrically conducting additive. The battery also includes a cathode current collector and a cathode active layer disposed on the cathode current collector. The cathode active layer includes a cathode active material; a polymeric binder, a solid state electrolyte and an electrically conducting additive. The battery also includes a solid state electrolyte, where the solid state electrolyte contacts both the anode active layer and the cathode active layer. The solid state electrolyte includes a blend of the polymeric binder with a pseudobinary sulfide, a pseudoternary sulfide, a pseudoquarternary sulfide, or a combination thereof.

In an exemplary embodiment, the anode active material is a hard carbon, a silicon, a silicon mixed with graphite, a carbon encapsulated silicon particle, Li₄Ti₅O₁₂; a transition metal, a metal sulfide, a lithium metal or an alloy of lithium metal, or a combination thereof.

In yet exemplary another embodiment, the cathode active material is lithium cobalt oxide, lithium nickel manganese cobalt oxide, lithium nickel manganese oxide, lithium nickel cobalt aluminum oxide, lithium iron phosphate oxide, lithium nickel cobalt aluminum oxide, spinel, or a combination thereof.

In yet exemplary another embodiment, the lithium nickel manganese cobalt oxide is LiNiₓMn_{y}Co_{(1-x-y)}O₂; the lithium nickel cobalt aluminum oxide is LiNiₓMn_{y}Al_{(1-x-y)}O₂, the lithium nickel manganese oxide is LiNiₓMn₍₁₋ₓ₎O₂, wherein each case x is 0.7 to 0.85, an y is less than 0.15.

In yet another exemplary embodiment, the solid state electrolyte includes a Li₂S—P₂S₅ system, a Li₂S—SnS₂ system, a Li₂S—SiS₂ system, a Li₂S—GeS₂ system, a Li₂S—B₂S₃ system, a Li₂S—Ga₂S₃ system, a Li₂S—P₂S₃ system, a Li₂S—Al₂S₃ system, a Li₂O—Li₂S—P₂S₅ system, a Li₂S—P₂S₅—P₂O₅ system, a Li₂S—P₂S₅—GeS₂ system, a Li₂S—P₂S₅—LiX system, where X=F, Cl, Br or I; a Li₂S—As₂S₅—SnS₂ system, a Li₂S—P₂S₅—Al₂S₃ system, a Li₂S—LiX—SiS₂, where X=F, Cl, Br or I.

In yet another exemplary embodiment, the solid state electrolyte is Li₆PS₅Cl.

In yet another embodiment, the polymeric binder is poly(vinylidene fluoride-hexafluoropropylene).

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an exemplary depiction of a solid state battery disclosed herein;

FIG. 2 is an exemplary depiction of the method of manufacturing a cathode active layer as described in Example 1; and

FIG. 3A is a graph that measures voltage versus capacity for a first charge and discharge cycle at a constant current rate of 0.2 C on the experimental and comparative battery;

FIG. 3B is a graph that measured capacity versus cycle time for both the experimental and the comparative battery. These measurements are made at variable current rates of 0.2 C, 0.5 C, 1 C, 2 C, 3 C and 5 C; and

FIG. 3C is a graph that measures capacity versus cycle times for both experimental and comparative batteries while being cycled at a current rate of 0.5 C at room temperature.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a synergistic cosolvent composition comprising a first solvent having a low polarity (hereinafter a “low-polar” solvent) and a second solvent that comprises an ether link is used to solvate polymeric binders that are used in the electrodes of sulfide all-solid-state batteries (hereinafter sulfide solid state batteries). All-solid-state batteries display properties (such as their working temperature range) that permit them to compete commercially with traditional lithium ion batteries. The sulfide solid state batteries contain sulfide electrolytes and the use of the synergistic cosolvent composition to solvate the polymeric binder prevents any reaction between the electrode and the electrolyte.

Disclosed herein too is a method of manufacturing an electrode that comprises mixing a synergistic cosolvent together with a polymeric binder, an electrically conductive additive, an active agent and optionally a solid state electrolyte to form an electrode active material composition (in slurry form) that is then disposed on a current collector to form an active layer. The current collector with the slurry disposed on it is subjected to further processing to form an electrode. The electrode may be an anode or a cathode depending upon the composition of the slurry that is disposed on it. In short, the electrode active material composition used in the manufacturing of an anode is different from that used in the manufacturing of a cathode. These differences in composition are discussed in detail later.

Disclosed herein too is a method of manufacturing an electrolyte composition that comprises mixing the synergistic cosolvent together with a polymeric binder and the solid state electrolyte. The respective electrodes (i.e., the cathodes and anodes) and the electrolyte composition may then be combined in a housing to form a solid state battery. Each of the ingredients used to manufacture the respective electrodes along with the methods of manufacturing the electrodes and the electrolyte are detailed below.

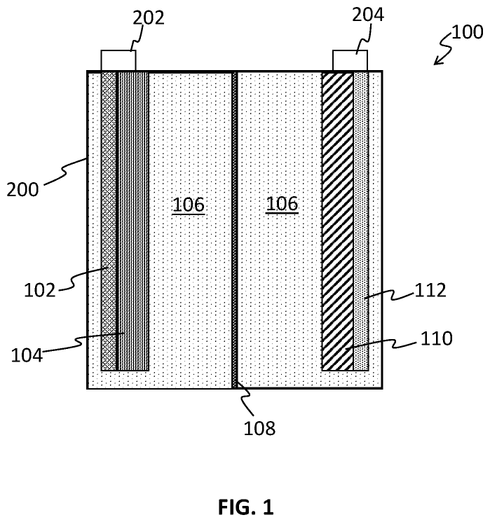

FIG. 1 depicts a cross-section of an exemplary solid state battery 100 that comprises an anode current collector 102, an anode active layer 104 disposed on the anode current collector 102, a solid state electrolyte 106, a separator 108, a cathode active layer 110 disposed on a cathode current collector 112. The various components of the solid state battery 100 are contained in a housing 200 that contains terminals 202 and 204 which are typically in electrical communication with a load (not shown). The anode current collector 102 and the cathode current collector 112 generally comprise metals. In an embodiment, the anode current collector 102 comprises stainless steel, copper, nickel, iron, titanium, or a combination thereof, while the cathode current collector 112 comprises stainless steel, aluminum, nickel, iron, titanium, or a combination thereof.

The anode active layer 104 and the cathode active layer 110 are generally manufactured by preparing an anode active material slurry and a cathode active material slurry and disposing the respective slurries on the anode current collector 102 and the cathode current collector 112. When the slurries are dried (i.e., all solvent used in the slurry is removed) the anode of the solid state battery 100 comprises the anode current collector 102 and the anode active layer 104 disposed on it, while the cathode comprises a cathode current collector 112 with the cathode active layer 110 disposed on it.

The solid state electrolyte 106 surrounds the anode and the cathode. The separator 108 is optional—it generally comprises an electrically insulating material and may not be used in the solid state battery 100 if desired.

The slurry used in the preparation of the anode active layer 104 is called an electrode-forming slurry and comprises a synergistic cosolvent composition, an electrically conductive additive, an anode active material, and a polymeric binder. Since these ingredients are typically used to form the anode active layer, the combination is also sometimes referred to as an anode active material slurry. The synergistic cosolvent composition, the electrically conductive additive, the anode active material and the polymeric binder are mixed to form the slurry, which is then disposed on the anode current collector 102 and allowed to dry. The dried slurry forms the anode active layer 104 and it contacts the anode current collector 102 to form the anode.

The slurry used in the preparation of the cathode active layer 110 is also called an electrode-forming slurry (because it contains most of the same ingredients as the slurry used to form the anode active layer) and comprises a synergistic cosolvent composition, an electrically conductive additive, a cathode active material, and a polymeric binder. Since these ingredients are typically used to form the cathode active layer, the combination is also sometimes referred to as a cathode active material slurry. The synergistic cosolvent composition, the electrically conductive additive, the cathode active material and the polymeric binder are mixed to form the slurry, which is then disposed on the cathode current collector 112 and allowed to dry. The dried slurry forms the cathode active layer 110 and it contacts the cathode current collector 112 to form the cathode.

In an embodiment, the synergistic cosolvent composition comprises a first solvent having a low polarity (hereinafter a “low-polar” solvent) and a second solvent that comprises an ether link. The synergistic cosolvent composition thus comprises a plurality of solvents one of which solubilizes the polymeric binder, while the other can be used to disperse the conductive additives and active materials so that a uniform dispersion of these ingredients in the polymeric binder is obtained. The synergistic cosolvent composition does not react with the solid state electrolyte, which preserves the life of the battery.

The first solvent (the low-polar solvent) comprises a substituted or unsubstituted linear, cyclic or aromatic hydrocarbon based solvent that has a dipole moment less than 4.0, preferably less than 3.5, preferably less than 3.0, preferably less than 2.0, and more preferably less than 1.75. The low-polar solvent preferably has a boiling point of greater than 100° C. By using a low-polar solvent, the sulfide solid state electrolyte can not only retain its chemical structure and ionic conductivity, but also mix uniformly with active material and carbon during the process of mixing to form a slurry, which is disposed on the current collector to form the respective electrodes. The slurry is disposed on a current collector to facilitate the formation of an electrode and hence is sometimes referred to as an electrode-forming slurry. The term “slurry” and “electrode-forming slurry” are therefore used interchangeably.

The low-polar solvent is preferably in liquid form at room temperature (23° C.) and pressure and has a structure (that may be substituted or unsubstituted) that is represented by formula:

CₙH₂ₙ₊₂ (1);

or

CₙH₂ₙ (2); where C is carbon, H is hydrogen and n is an integer greater than 5, preferably greater than 6. The term “substituted” means that at least one hydrogen atom on the group is replaced with another atom or group, provided that the designated atom's normal valence is not exceeded. Exemplary groups that may be present on a “substituted” position include, but are not limited to, nitro (—NO₂), cyano (—CN), hydroxy (—OH), oxo (═O), amino (—NH₂), mono- or di-(C₁₋₆)alkylamino, alkanoyl (such as a C₂₋₆ alkanoyl group such as acyl), formyl (—C(═O) H), carboxylic acid or an alkali metal or ammonium salt thereof; esters (including acrylates, methacrylates, and lactones) such as C₂₋₆ alkyl esters (—C(═O)O-alkyl or —OC(═O)-alkyl) and C₇₋₁₃ aryl esters (—C(═O)O-aryl or —OC(═O)-aryl); amido (—C(═O)NR₂ wherein R is hydrogen or C₁₋₆ alkyl), carboxamido (—CH₂C(═O)NR₂ wherein R is hydrogen or C₁₋₆ alkyl), halogen, thiol (—SH), C₁₋₆ alkylthio (—S-alkyl), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl having at least one aromatic ring (e.g., phenyl, biphenyl, naphthyl, or the like, each ring either substituted or unsubstituted aromatic), C₇₋₁₉ arylalkyl having 1 to 3 separate or fused rings and from 6 to 18 ring carbon atoms, arylalkoxy having 1 to 3 separate or fused rings and from 6 to 18 ring carbon atoms, C₇₋₁₂ alkylaryl, C₄₋₁₂ heterocycloalkyl, C₃₋₁₂ heteroaryl, C₁₋₆ alkyl sulfonyl (—S(═O) 2-alkyl), C₆₋₁₂ arylsulfonyl (—S(═O)₂-aryl), or tosyl (CH₃C₆H₄SO₂—). When a group is substituted, the indicated number of carbon atoms is the total number of carbon atoms in the group, excluding those of any substituents. For example, the group —CH₂CH₂CN is a C₂ alkyl group substituted with a cyano group. The substitutions listed above are envisioned above may occur so long as the dipole moment of the resulting molecule lies below 2.0.

Examples of the low-polar solvent includes pentane, cyclopentane, hexane, cyclohexane, heptane and isomers thereof, toluene, ethylbenzene, p-xylene, m-xylene, o-xylene, anisole, or a combination thereof. Anisole is preferred.

The concentration of the first solvent (the “low-polar” solvent) in the synergistic cosolvent composition is 10 to 60 weight percent (wt %), preferably 20 to 50 wt %, based on a total weight of the synergistic cosolvent composition.

The second solvent is an ether-based solvent that is effective to solubilize the binder used in the electrodes. In an embodiment, the ether-based solvent comprises one or more ether (—O—) linkages. The ether-based solvent is effective to solubilize a binder that comprises poly(vinylidene fluoride). The binder may be a homopolymer, a copolymer, or a polymeric blend that contains poly(vinylidene fluoride). In an exemplary embodiment, the ether-based solvent is effective to solubilize a binder that comprises poly(vinylidene fluoride-co-hexafluoropropylene) (PVDF-HFP) copolymer. The total concentration of the binder in the ether-based solvent is 5 to 50 wt %, preferably 6 to 10 wt %, based on a total weight of the binder and the ether-based solvent.

The ether-based solvent comprises an ether having a structure determined by formula (3)

C₂ₙH₂ₙ₊₂O (3), where C is carbon, H is hydrogen, O is oxygen, and where n is an integer greater than 1. (n>1). The ether-based solvents can comprise linear ethers, cyclic ethers, or a combination thereof. While both asymmetrical or symmetrical ether-based solvents can be used, it is desirable to use symmetrical solvents. It is desirable to use an ether-based solvent that has a boiling point of less than 100° C.

Examples of such solvents include dimethyl ether (DME), diethyl ether, dipropyl ether, dibutyl ether, dimethoxymethane, tetraethylene glycol, methyl tert-butyl ether, dimethyl ether (TEGDME), diglyme, ethyl diglyme, butyl diglyme, tetrahydrofuran (THF), dioxane, methyl tert-butyl ether, diisopropyl ether, 2-butoxyethanol, cyclopentyl methyl ether, 2-methyltetrahydrofuran, or a combination thereof. Dimethyl ether is a preferred solvent.

The concentration of the second solvent (the “ether-based” solvent) in the synergistic cosolvent composition is 40 to 90 wt %, preferably 50 to 80 wt %, based on a total weight of the synergistic cosolvent composition.

The synergistic cosolvent composition is used in an electrode-forming slurry (a slurry that can be used to form the electrodes) in an amount of 20 to 80 wt %, preferably 30 to 70 wt %, based on the total weight of the slurry.

As noted above, the slurry used to form the electrodes comprises an electrically conducting additive, a polymeric binder, an active material (the active material can be an anode active material or a cathode active material depending upon which particular electrode (anode or cathode) it is used in. The slurry may also contain a lithium-containing sulfide (which may also be used in the electrolyte) and the polymeric binder.

The electrically conducting additive preferably comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof. It is desirable for the electrically conducting composition to form an electrically conducting network that extends from a surface of the current collector to the surface of the electrolyte.

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, preferably 10 to 50 nanometers. They have lengths of 20 to 10,000 nanometers, preferably 200 to 5000 nanometers. Aspect ratios greater than 10, preferably greater than 50 and more preferably greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode.

Activated carbon also called activated charcoal, is a form of carbon that has a surface area in excess of 3,000 m²/gm as determined by gas adsorption. It can be used in conjunction with other electrically conducting carbonaceous elements listed herewith. Examples of carbon black or activated carbon that can be used in the electrode-forming slurry are KELTJEN™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalized π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, preferably greater than 10,000 micrometers. The are produced by drawing pitch or polyacrylonitrile polymeric fibers under high pressures and temperatures of over 1500° C., preferably at temperatures greater than 2200° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network. In an exemplary embodiment, the carbon nanotubes typically are used in the largest amount when compared with the other carbonaceous ingredients.

The active layer may contain the electrically conducting additive in an amount of up to 5 wt %, preferably 1 to 4 wt %, based on a total weight of the active layer.

The electrode-forming slurry also comprises a polymeric binder. The polymeric binder binds the electrically conducting additive and the active material so that they remain in contact with the current collector and do not get dispersed in the electrolyte during the manufacturing process or during use. The polymeric binder preferably does not reduce electrical conductivity of the active layer disposed on the current collector. The active layer comprises the electrically conducting additive and the respective anode or cathode active material.

The polymeric binder is preferably a fluorine containing homopolymer or copolymer. In a preferred embodiment, the binder is a fluorine containing copolymer. In an embodiment, the fluorine containing copolymer is at least one of poly(vinylidene fluoride-co-chlorotrifluoroethylene) (abbreviated as P(VDF-CTFE)), poly(vinylidene fluoride-trifluoroethylene) (abbreviated as P(VDF-TeFE)), poly(vinylidene fluoride-trifluoroethylene-chlorofluoroethylene) terpolymer (abbreviated as P(VDF-TrFE-CFE)), poly(vinylidene fluoride-hexafluoropropylene) (abbreviated as P(VDF-HFP) or PVDF-HFP), or a combination thereof. In a preferred embodiment, the polymeric binder used in the active layer is poly(vinylidene fluoride-hexafluoropropylene) copolymer. The polymeric binder has a weight average molecular weight of 5,000 to 1,000,000 grams per mole, preferably 50,000 to 750,000 grams per mole, and more preferably 75,000 to 500,000 grams per mole measured using gel permeation chromatography with a polystyrene standard.

In an embodiment, the polyvinylidene content of any of the aforementioned binders is 80 to 95 wt %, based on a total weight of the polymeric binder. The remaining polymer content of the copolymer is 5 to 20 wt %, based on the total weight of the polymeric binder. For example, if the polymeric binder is a poly(vinylidene fluoride-hexafluoropropylene) copolymer, then the polyvinylidene content of the copolymer is 80 to 95 wt %, based on a total weight of the polymeric binder, while the poly hexafluoropropylene content of the copolymer is 5 to 20 wt %, based on a total weight of the copolymer.

The total weight of the polymeric binder in the active layer after the solvent is removed is less than 10 wt %, preferably less than 8 wt %, and more preferably less than 5 wt %, and more preferably less than 2 wt % of a total weight of the active layer. The polymeric binder is present in an amount of greater than 0.1 wt % of the total weight of the active layer. A lower weight of the polymeric binder in the active layer facilitates a lower reduction in the electrically conducting capabilities of the active layer. In other words, the lower the amount of the polymeric binder, the greater the electrical conducting capacity of the active layer will be. The active layer is disposed on the current collector and comprises the pertinent (anode or cathode) active material, the electrically conducting additive and the polymeric binder.

The electrode-forming slurry contains an active material. The active material may be different depending upon whether the slurry is used to form the anode active layer or the cathode active layer.

Anode active materials include some of the aforementioned carbonaceous materials, hard carbon, silicon, silicon mixed with graphite, carbon encapsulated silicon particles, Li₄Ti₅O₁₂; transition metals such as, for example, tin, metal oxides, metal sulfides, (e.g., TiO₂, FeS, and the like) lithium metal and alloys, or a combination thereof. Exemplary active materials may include graphite, hard carbon, activated carbon, nanoform carbon, silicon, silicon oxides, carbon encapsulated silicon nanoparticles, or a combination thereof. In some such embodiments, the anode active material may be intercalated with lithium (e.g., using pre-lithiation methods known in the art).

Hard carbon is a solid form of carbon that cannot be converted to graphite by heat-treatment, even at temperatures as high as 3000° C. It is also known as char, or non-graphitizing carbon. Hard carbon is produced by heating carbonaceous precursors to approximately 1000° C. in the absence of oxygen. Among the precursors for hard carbon are polyvinylidene chloride (PVDC), lignin and sucrose. Other precursors, such as polyvinyl chloride (PVC) and petroleum coke, produce soft carbon, or graphitizing carbon. Soft carbon can be readily converted to graphite by heating to 3000° C.

Cathode active materials may include lithium cobalt oxide (LCO, sometimes called “lithium cobaltate” or “lithium cobaltite”-one variant of which is LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂(PO₄)₃), and other lithium transition-metal oxides. Surface-coated and/or doped cathode materials mentioned above. e.g., LiNbO₃-coated LiMn₂O₄ and Al-doped LiMn₂O₄, may also be used. Low voltage cathode materials (e.g., lithiated metal oxide/sulfide (e.g., LiTiS₂), lithium sulfide and sulfur) may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)}O₂, LiNiₓMn_{y}Al_{(1-x-y)}O₂, LiNiₓMn₍₁₋ₓ₎O₂, Li₁₊ₓMO₂, where x is equal to or greater than about 0.7, 0.75, 0.80, 0.85, or more and where y is less than 0.15, preferably less than 0.1. In some embodiments, NMC811 may be used, where in the foregoing formula x is about 0.8 and y is about 0.1.

The anode active material may be used in the anode active layer respectively in an amount of 60 to 99 wt %, based on a total weight of the anode active layer. The cathode active material may be used in the cathode active layer respectively in an amount of 70 to 90 wt %, based on a total weight of the cathode active layer.

In an embodiment, the electrode-forming slurry may also optionally contain a small portion of the solid state electrolyte. The solid state electrolyte generally comprises a pseudobinary sulfide, a pseudoternary sulfide, a pseudoquarternary sulfide, or a combination thereof. Examples of pseudobinary sulfides include the Li₂S—P₂S₅ system (e.g., Li₃PS₄, Li₇P₃S₁₁ and Li_{9.6}P₃S₁₂), the Li₂S—SnS₂ system (e.g., Li₄SnS₄), the Li₂S—SiS₂ system, the Li₂S—GeS₂ system, the Li₂S—B₂S₃ system, the Li₂S—Ga₂S₃ system, the Li₂S—P₂S₃ system, the Li₂S—Al₂S₃ system, or a combination thereof. Examples of pseudoternary sulfides include the Li₂O—Li₂S—P₂S₅ system, the Li₂S—P₂S₅—P₂O₅ system, the Li₂S—P₂S₅—GeS₂ system (e.g., Li_{3.25}Ge_{0.25}P_{0.75}S₄ and Li₁₀GeP₂S₁₂), the Li₂S—P₂S₅—LiX system (where X=F, Cl, Br, or I, examples of which include Li₆PS₅Br, Li₆PS₅Cl, L₇P₂S₈I and Li₄PS₄I), the Li₂S—As₂S₅—SnS₂ system (e.g., Li_{3.833}Sn_{0.833}AS_{0.166}S₄), the Li₂S—P₂S₅—Al₂S₃ system, Li₂S—LiX—SiS₂ (where X=F, Cl, Br or I, which includes examples 0.4LiI·0.6Li₄SnS₄ and Li₁₁Si₂PS₁₂.

The active layer may contain the pseudobinary sulfide, a pseudoternary sulfide, a pseudoquarternary sulfide, or a combination thereof in an amount of 10 to 40 wt %, based on a total weight of the active layer.

The electrode-forming slurry can be manufactured in several different ways. The active layers manufactured using the electrode-forming slurry can be formed in a one-step process or in multiple steps. In one embodiment, in one method of manufacturing the electrode-forming slurry, the synergistic solvent composition, the electrically conducting composition, the polymeric binder, the anode or the cathode active materials and the optional solid state electrolyte can be mixed in a single mixing device such as a blender for an appropriate amount of time to form the slurry. The time of mixing can be 30 minutes to 5 hours. The slurry with the appropriate active material is then disposed on the respective current collector to form the anode or cathode. The slurry after being disposed on the current collector is subjected to drying to form the active layer.

The drying may be conducted at a temperature of 50 to 80° C. for a period of 30 minutes to 10 hours, preferably 1 to 5 hours.

The electrode-forming slurry can also be manufactured in a two step process. In a first step the desired active material (anode active material or cathode active material) is blended with the electrically conducting additive and the low-polar solvent (the first solvent) and mixed for a time period of 30 minutes to 5 hours to form a first slurry. An optional small amount of the solid state electrolyte may also be added to the blend if desired. The mixing is conducted in a planetary mixer, although other blenders such as Waring blenders, Henschel mixers, single and multiple screw extruders may also be used.

In a second step, the polymeric binder is mixed with the ether-based solvent (the second solvent) and mixed for a time period of 30 minutes to 5 hours to form a second slurry. An optional small amount of the solid state electrolyte may also be added to the second slurry if desired. As noted above, the ether-based solvent is compatible with the polymeric binder and can solubilize a portion of the binder or can completely solubilize the entire volume of binder. While the term “second slurry” is used here, it is to be noted that the product of the second step may be a solution.

The first slurry is then mixed with the second slurry to for the electrode-forming slurry. The mixing of the first and second slurries may be conducted in an extruder or a planetary mixing. It may therefore be a batch process or a continuous process. The resulting electrode-forming slurry is then applied to the appropriate current collector (the anode current collector to form the anode or the cathode current collector to form the cathode) and subjected to drying. Compression may optionally be applied during the drying process to produce a compact electrode.

The drying may be conducted at a temperature of 50 to 80° C. for a period of 30 minutes to 10 hours, preferably 1 to 5 hours. During the drying the low-polar solvent and the ether-based solvent undergo evaporation to produce a dried electrode (anode or cathode as the case may be).

In an embodiment, the synergistic cosolvent composition may also be used to fabricate the solid state electrolyte. The low-polar solvent (the first solvent—e.g., anisole) may be first mixed with the solid state electrolyte (these are listed above one example of which is Li₆PS₅Cl) in the desired quantity to form a first blend. The ether-based solvent (the second solvent—e.g., dimethyl ether) is then mixed with the binder in the desired quantity to form the second blend. The respective blending is preferably conducted in a planetary mixer. Other mixers such as those listed above may also be used. The first blend and the second blend are then mixed together in the planetary mixer to produce an electrolyte slurry with the cosolvent. The electrolytic slurry is then applied to a non-stick substrate and allowed to dry at 60° C. (during which the cosolvents are dried and removed from the slurry). After drying the solid state electrolyte may be compression molded or may be pulverized to form a powder. The solid state electrolyte may then be added to the battery in the form of a slab or in the form of a powder. The solid state electrolyte generally surrounds the anode and cathode in the battery as may be seen in the FIG. 1.

The compositions and methods detailed above may be detailed in the following non-limiting examples.

### EXAMPLE

### Example 1

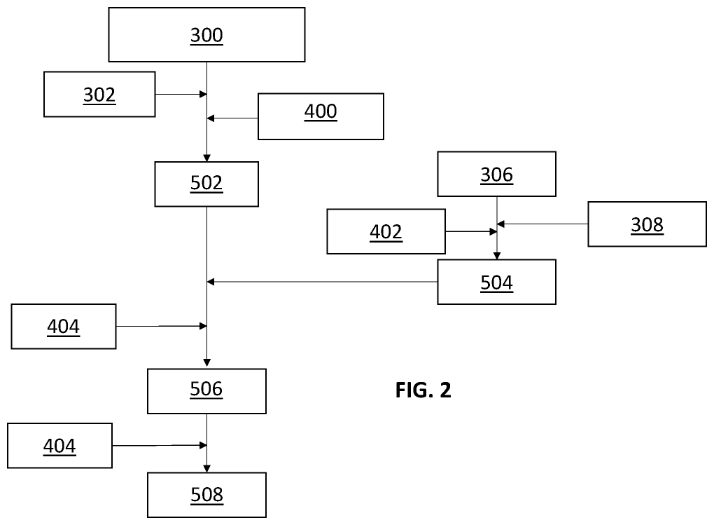

This example is conducted to demonstrate the manufacturing of a cathode for a solid state electrolytic cell. FIG. 2 depicts the mixing steps. In a first mixing step (300), the cathode active material (NMC, 1.4 grams (g)), the electrically conducting additive (Super P, 0.01 g) and the solid state electrolyte (Li₆PS₅Cl, 0.59 g) are mixed with the low-polar solvent (302) (anisole, 0.7 g) in a planetary mixer (400) at 1000 rpm for 2 hours to form a first slurry (termed an electrode suspension (502). In a second step, the binder (306) (PVDF-HFP, 0.04 g) is mixed with the ether-based solvent (308) (dimethyl ether, 2.1 g) in a planetary mixer (402) for 1 hour at 60° C. to form a second slurry (504) (also termed a binder solution). The first slurry and the second slurry are then mixed together in the planetary mixer (404) at 600 rpm for 30 minutes to form an electrode-forming slurry (506) (also called a cathode slurry), which is disposed on the current collector and dried at 60° C. for 30 minutes to form the cathode (508).

### Example 2

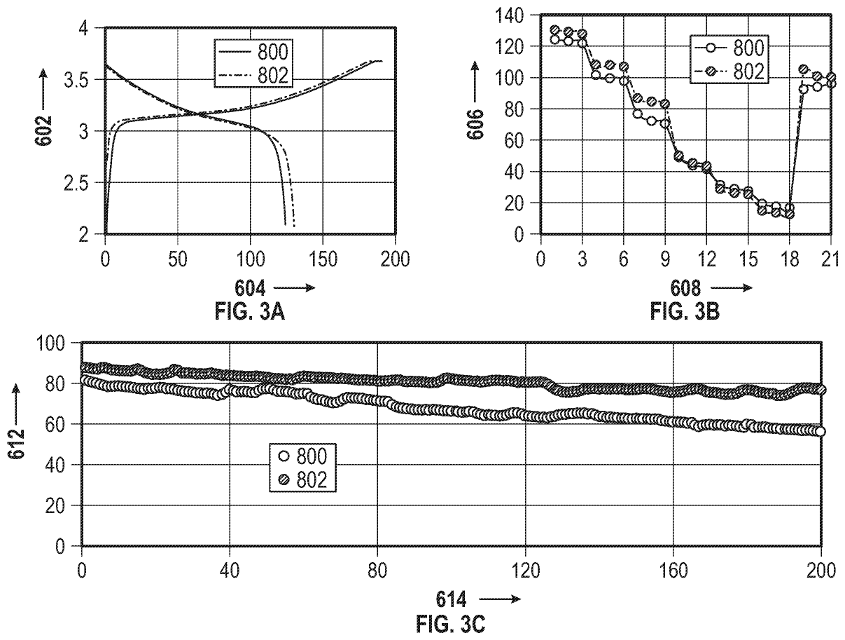

This example was conducted to demonstrate the improvement in the structure and performance of a battery that uses the synergistic cosolvent composition disclosed herein versus a battery that does not use the synergistic cosolvent composition. Two equivalent batteries having the same anode active layer and cathode active layer were prepared except that in one case the cathode active layer used the disclosed cosolvent composition during manufacturing, while the comparative battery used only an ether-based solvent (DME) as the solvent for processing the cathode active layer. Both batteries (the experimental battery that uses the cosolvent and the comparative battery that uses only the DME) were subjected to a series of tests, the results of which are shown in the FIGS. 3A, 3B and 3C. The test geometry used for the battery was a pellet cell. The anode active layer is a lithium-indium alloy having a thickness of 100 micrometers. The pellet cell is charged with a different constant current rate (0.2 Coulomb (C) in FIGS. 3A and 3C, and 0.2 C, 0.5 C, 1 C, 2 C, 3 C and 5 C in the FIG. 3B) to a cut-off voltage of 3.68V, followed by a constant voltage charge of 3.68V until the current rate is lower than 0.5 C, and then a constant current discharge to 2.0V. The test temperature is room temperature (25° C.). The voltage range is 2.0V to 3.68V.

FIGS. 3A, 3B and 3C are graphs that details the charge-discharge characteristics, rate performance and cycling at room temperature of the two batteries (the experimental battery whose electrodes were manufactured using the cosolvent (802) and the comparative battery whose electrodes were manufactured using the single solvent DME (800)). FIG. 3A is a graph that measures voltage (V) (602) versus capacity (mAh/g) (604) for a first charge and discharge cycle at a constant current rate of 0.2 C on the experimental (802) and comparative (800) battery. FIG. 3B is a graph that measured capacity (mAh/g) (606) versus the number of cycles (608) for both the experimental (802) and the comparative (800) battery. These measurements are made at variable current rates of 0.2 C, 0.5 C, 1 C, 2 C, 3 C and 5 C.

FIG. 3C is a graph that measures capacity (mAh) (612) versus the number of cycles (614) for both experimental (802) and comparative (800) batteries while being cycled at a current rate of 0.5 C at room temperature.

From these three graphs it may be seen that the electrode manufactured by using the cosolvent can deliver a higher first cycle columbic efficiency, an enhanced 1 C discharge capacity and a better battery cycling performance when compared with the electrode fabricated by using only a single solvent (DME).

In an embodiment, the final electrode-forming slurry may be subjected to roll milling to remove the solvent and the further enable shear mixing of the ingredients. The rolled-sheet resulting from the roll milling operation may then be inserted onto a current collector and bonded with it using the polymeric binder as an adhesive or alternatively, by using an additional electrically conducting adhesive.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of manufacturing an electrode-forming slurry comprising:
mixing together an active material, an electrically conducting material and optionally a solid state electrolyte with a low-polar solvent; where the low-polar solvent has a dipole moment of less than 4 and a boiling point greater than 100° C. to form a first slurry; where the active material is an anode active material or a cathode active material;
mixing together a polymeric binder and an ether-based solvent to form a second slurry; and
mixing the first slurry with the second slurry to form the electrode-forming slurry.

2. The method of claim 1, further comprising disposing the electrode-forming slurry on a current collector and subjecting the current collector to an increased temperature.

3. The method of claim 2, further comprising drying the electrode-forming slurry to form an electrode.

4. The method of claim 1, where the low-polar solvent has a structure represented by formula:
CₙH₂ₙ₊₂ (1);
or
CₙH₂ₙ (2); where C is carbon, H is hydrogen and n is an integer greater than 5 and where the structures of formula (1) or formula (2) are substituted or non-substituted.

5. The method of claim 1, where the low-polar solvent is pentane, cyclopentane, hexane, cyclohexane, heptane and isomers thereof, toluene, ethylbenzene, p-xylene, m-xylene, o-xylene, anisole, or a combination thereof.

6. The method of claim 1, where the low-polar solvent is anisole.

7. The method of claim 1, where the ether-based solvent comprises an ether having a structure determined by formula (3)
C₂ₙH₂ₙ₊₂O (3), where C is carbon, H is hydrogen, O is oxygen, and where n is an integer greater than 1; and where the structure of formula (3) is substituted or non-substituted.

8. The method of claim 1, where the ether-based solvent is dimethyl ether, diethyl ether, dipropyl ether, dibutyl ether, dimethoxymethane, tetraethylene glycol, methyl tert-butyl ether, dimethyl ether, diglyme, ethyl diglyme, butyl diglyme, tetrahydrofuran (THF), dioxane, methyl tert-butyl ether, diisopropyl ether, 2-butoxyethanol, cyclopentyl methyl ether, 2-methyltetrahydrofuran, or a combination thereof.

9. The method of claim 1, where the ether-based solvent is dimethyl ether.

10. The method of claim 1, where the solid state electrolyte is a pseudobinary sulfide, a pseudoternary sulfide, a pseudoquarternary sulfide, or a combination thereof.

11. The method of claim 1, where the solid state electrolyte is Li₆PS₅Cl.

12. A method of manufacturing a solid state electrolyte for a solid state battery comprising:
mixing a low-polar solvent and an ether-based solvent with a solid state electrolyte and a polymeric binder; where the low-polar solvent has a dipole moment of less than 4 and a boiling point of greater than 100° C.; where the solid state electrolyte is a pseudobinary sulfide, a pseudoternary sulfide, a pseudoquarternary sulfide, or a combination thereof.

13. The method of claim 12, where the polymeric binder is poly (vinylidene fluoride-co-chlorotrifluoroethylene), poly(vinylidene fluoride-trifluoroethylene), poly(vinylidene fluoride-trifluoroethylene-chlorofluoroethylene) terpolymer, poly(vinylidene fluoride-hexafluoropropylene), or a combination thereof.

14. A battery comprising:
an anode current collector;
an anode active layer disposed on the anode current collector; where the anode active layer comprises an anode active material; a polymeric binder and an electrically conducting additive;
a cathode current collector;
a cathode active layer disposed on the cathode current collector; where the cathode active layer comprises a cathode active material; a polymeric binder, a solid state electrolyte and an electrically conducting additive; and
the solid state electrolyte; where the solid state electrolyte contacts both the anode active layer and the cathode active layer; and where the solid state electrolyte comprises a blend of the polymeric binder with a pseudobinary sulfide, a pseudoternary sulfide, a pseudoquarternary sulfide, or a combination thereof.

15. The battery of claim 14, where the anode active material is a hard carbon, a silicon, a silicon mixed with graphite, a carbon encapsulated silicon particle, Li₄Ti₅O₁₂; a transition metal, a metal sulfide, a lithium metal or an alloy of lithium metal, or a combination thereof.

16. The battery of claim 14, where the cathode active material is lithium cobalt oxide, lithium nickel manganese cobalt oxide, lithium nickel manganese oxide, lithium nickel cobalt aluminum oxide, lithium iron phosphate oxide, lithium nickel cobalt aluminum oxide, spinel, or a combination thereof.

17. The battery of claim 16, where the lithium nickel manganese cobalt oxide is LiNiₓMn_{y}Co_{(1-x-y)}O₂; the lithium nickel cobalt aluminum oxide is LiNiₓMn_{y}Al_{(1-x-y)}O₂, the lithium nickel manganese oxide is LiNiₓMn₍₁₋ₓ₎O₂, wherein each case x is 0.7 to 0.85, an y is less than 0.15.

18. The battery of claim 14, where the solid state electrolyte includes a Li₂S—P₂S₅ system, a Li₂S—SnS₂ system, a Li₂S—SiS₂ system, a Li₂S—GeS₂ system, a Li₂S—B₂S₃ system, a Li₂S—Ga₂S₃ system, a Li₂S—P₂S₃ system, a Li₂S—Al₂S₃ system, a Li₂O—Li₂S—P₂S₅ system, a Li₂S—P₂S₅—P₂O₅ system, a Li₂S—P₂S₅—GeS₂ system, a Li₂S—P₂S₅—LiX system, where X=F, Cl, Br or I; a Li₂S—As₂S₅—SnS₂ system, a Li₂S—P₂S₅—Al₂S₃ system, a Li₂S—LiX—SiS₂, where X=F, Cl, Br or I.

19. The battery of claim 14, where the solid state electrolyte is Li₆PS₅Cl.

20. The battery of claim 14, where the polymeric binder is poly(vinylidene fluoride-hexafluoropropylene).
